(19) United States
(12) Patent Application Publication
(10) Pub. No.: US 2003/0117438 A1
(43) Pub. Date: Jun. 26, 2003

(54) System and method for manipulating data using a control

(75) Inventors: Kenneth C. Wyke, Culpeper, VA (US); John Moore, Falls Church, VA (US); Archie Spivey, Myrtle Beach, SC (US)

Correspondence Address: HOGAN & HARTSON LLP, IP GROUP, COLUMBIA SQUARE, 555 THIRTEENTH STREET, N.W., WASHINGTON, DC, 20004, US

(73) Assignee: Lockheed Martin Corporation

(21) Appl. No.: 10/321,641

(22) Filed: Dec. 18, 2002

Related U.S. Application Data
(60) Provisional application No. 60/341,862, filed on Dec. 21, 2001.

(51) Int. Cl. G09G 5/00

(52) U.S. Cl. 345/764

(57) ABSTRACT

A system and method for using a control to manipulate data is disclosed. The data is stored in a memory and is manipulated by the control in response to inputs. The control may operate within an operating environment that managers the control. The control has a support members string to list controls compatible with the control. The control also has a pointer array with pointers correlating to the listed controls within the support members string. The control also has a type string to identify itself to the operating environment. The control accesses another control by determining whether the other control has been listed in the support members string. If yes, then the control accesses the other control for additional properties and methods.

### CROSS REFERENCE TO RELATED APPLICATIONS

This application claims benefit of U.S. Provisional Patent Application No. 60/341,862 entitled “Electronic Interactive Communication System and the Method Therefor,” filed Dec. 21, 2001, which is hereby incorporated by reference.

### BACKGROUND OF THE INVENTION

1. Field of the Invention

The present invention relates to an electronic interactive communication system, and more particularly, the invention relates to a system and method with improved distributed interactive communication between using controls within a software operating environment.

2. Discussion of the Related Art

The number of computing platforms has markedly increased in recent years. Palm-size and/or portable computing devices have become commonplace. Further, the number of different versions of a particular platform has increased as well, each with specific operating systems. A variety of software programs also have been created to execute on the computing platforms. Conventional computing devices can store information and program code in memory or receive the information from another device to enable executing the programs. With the multitude of computing platforms and operating systems, programs and information should be conceived with the ability to execute and be utilized in many operating environments.

A software control may enable different programs operating on different platforms. A software control may be a program module that enhances the functionality of a program. A control may act as a user interface function that allows the user to manipulate information stored in the memory of a computing platform. Controls may add functionality by calling existing components to blend in and appear as normal parts of the program. In general, however, these controls are dormant until activated and may not reside passively within a computing environment. This drawback may reduce the effectiveness of the controls and restrict the ability of the controls to interact within the software environment and other programs and controls. Further, conventional controls may not access the properties and methods of other controls without causing that control to become active.

### SUMMARY OF THE INVENTION

Accordingly, the present invention is directed to a system and method for manipulating data on a computing platform using a control.

Additional features and advantages of the invention will be set forth in the description that follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, discloses a control for manipulating data stored in a memory coupled to a processor. The processor may receive data to associate with the data within an operating environment. The control also includes a support members string to list a compatible control within the operating environment. The control also includes a pointer array having a pointer for the compatible control. The pointers are used when the control accesses the compatible control. The control also may include a key string for registering the control with the operating environment.

According to the disclosed embodiments, a method for accessing a second control from a first control within an operating environment is disclosed. The operating environment includes a software program utilizing the first and second controls. The method includes determining whether the second control is listed within a support members string of the first control. The method also includes identifying a pointer within a pointer array in the first control according to the support members string. The method also includes accessing the second control according to the pointer.

According to the disclosed embodiments, a system having a control for manipulating data within an operating environment is disclosed. The system includes a command received at the control. The system also includes a pointer array within the control that indicates another control to be accessed in response to the command. The system also includes a display for the operating environment. The control executes a method in response to the command using the another control to enable an event on the display.

According to the disclosed embodiments, a computing device having an operating environment for executing a software program is disclosed. The computing device includes a processor coupled to a memory storing instructions for the software program. The computing device includes a first control having a first type string and a first pointer array. The first type string identifies the first control to the operating environment. The computing device also includes a second control having a second type string. The second type string identifies the second control to the operating environment. The computing device also includes a first pointer within the first pointer array that identifies the second control to the first control such that the first control accesses the second control.

According to the disclosed embodiments, a system for manipulating data for a software program executing in an operating environment is disclosed. The system includes a control identified by the operating environment. The control manipulates the data in response to a user input. The system also includes a pointer array within the control to identify another control accessible by the control. The operating environment sets a pointer within the pointer array to identify the another control.

According to the disclosed embodiments, a method for manipulating data stored within a memory coupled to an operating environment having a plurality of controls is disclosed. The method includes determining whether a first control is compatible with a second control. The method also includes identifying a pointer within the first control that correlates to the second control. The method also includes accessing the second control from the first control. The method also includes retrieving data from the memory according to the first control.

According to the disclosed embodiments, a method for constructing a control to access another control within an operating environment is disclosed. The method includes receiving a modified type string at the control from the operating environment for the another control. The method also includes placing the modified type string in a support members string within the control. The method also includes assigning a pointer within the control to access the another control according to the modified type string.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIG. 1 illustrates a block diagram of a data structure for a software control in accordance with an embodiment of the present invention.

FIG. 2 illustrates a control within an operating environment in accordance with an embodiment of the present invention.

FIG. 3 illustrates a plurality of controls within an operating environment in accordance with an embodiment of the present invention.

FIG. 4 illustrates a flowchart for accessing controls in accordance with an embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

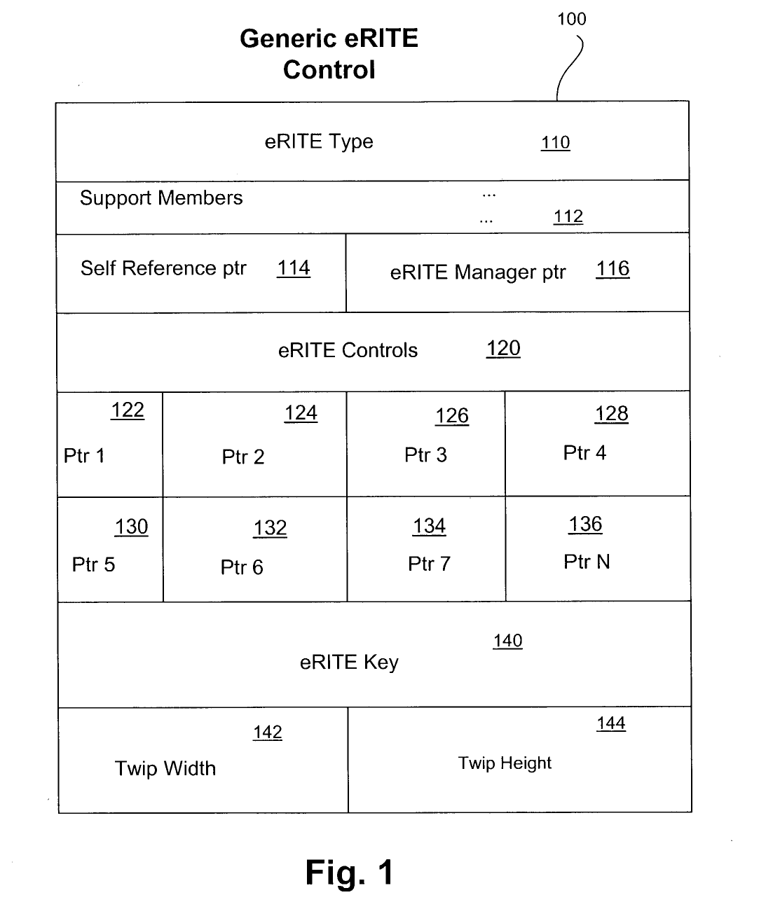

FIG. 1 depicts a block diagram of a data structure for a software control 100 in accordance with an embodiment of the present invention. Control 100 may be a block of software code that is placed into an operating environment, and executes in that environment. Control 100 may be comprised of strings of code and memory location pointers. Control 100 may be known as an e-Reusable Information Technology Environment (“eRITE”) control. Control 100 may be stored within a memory on a computing platform. Alternatively, control 100 may be “dropped” into an operating environment by being downloaded into memory on the computing platform. If dropped into an operating environment, control 100 should be compatible with other controls within the operating environment.

The operating environment may reside on any computing platform that includes a processor, memory, and the means, such as software code, to execute instructions for operations on the platform. The computing platform also may be known as a unit or device that includes any computer, such as a desktop, a portable computer, a laptop, a personal digital assistant (“PDA”), and the like. The computing platform also may be a network of computers or other data exchange devices.

Control 100 may be one of many different types of controls used to enhance a program within the operating environment. For example, if the control is to provide functionality for displaying maps on a device, the control may be a map control, compass control, or the like. Control 100 also may be a mode control or data control for the device. Control 100 also may be an information control, a track data control, or a tree control. Control 100 may act as a user interface to manipulate data stored within memory that is used by the software program. For example, control 100 may interact with a user to manipulate maps stored on a hand-held device. The distinctive aspects of the different controls may reside in their functionality as opposed to their structure. Thus, control 100 is not limited in the functionality it may provide to an operating system or the programs executing thereon.

Control 100 may include, but is not limited to, various properties embodied in its data structure. Control 100 includes a type string 110 that denotes the overall type of control 100. Type string 110 allows the operating environment to identify control 100 among the other controls. For example, control 100 may be identified as a map or compass control by type string 110. Type string 110 also may have input and output functionality.

Control 100 also includes support members string 112. Support members string 112 includes a comma-separated string that lists the other controls accessible by control 100. For example, a compass control may be used to move a map control. Thus, the map control would be listed in support members string 112 of the compass control. The controls within support members string 112 may be known as compatible controls. In addition, the listed compatible controls should be recognized by the operating environment. Support members string 112 also may have input and output functionality. Control 100 also may include self reference pointer 114 that acts as a pointer to control 100 itself as seen from other controls. Self reference pointer 114 allows control 100 to manipulate some of its properties that otherwise would not be accessible to control 100, such as left, top, visible, and the like. Self reference pointer 114 also may have input functionality.

Control 100 also includes a manager pointer 116. Manager pointer 116 may be known as an eRITE pointer. Manager pointer 116 may point to a manager control within the operating system. The manager control may be a project manager for the executed program, or, alternatively, be running passively within the operating environment to manage the controls and information to and from the controls. Manager pointer 116 may be used if control 100 desires to access any of the exposed properties or methods of the project manager. Manager pointer 116 may have input functionality.

Control 100 also includes control pointer array 120. Control pointer array 120 is an array of pointers to the controls listed in support members string 112, provided the controls exist in the current program, or project. For example, control pointer array may comprise pointers 122, 124, 126, 128, 130, 132, 134, and 136, up to an nth number of pointers. Pointers 122-136 may be used when control 100 desires to access the exposed properties or methods of the listed controls. For example, the “pan” method of a map control may be accessed. Pointer 130 may be identified as indicating the map control. Control pointer array 120 may have input and output functionality.

Key string 140 may be part of a security scheme for the operating environment of control 100. A managing control may use key string 140 when control 100 is identified to register control 100, or to perform a security check. Key string 140 may have special input and output functionality. Twip width 142 indicates the width of control 100 in twips. Twip height 144 indicates the height of control 100 in twips. Twip width 142 and twip height 144 may have output functionality and may be applicable if control 100 is displayed.

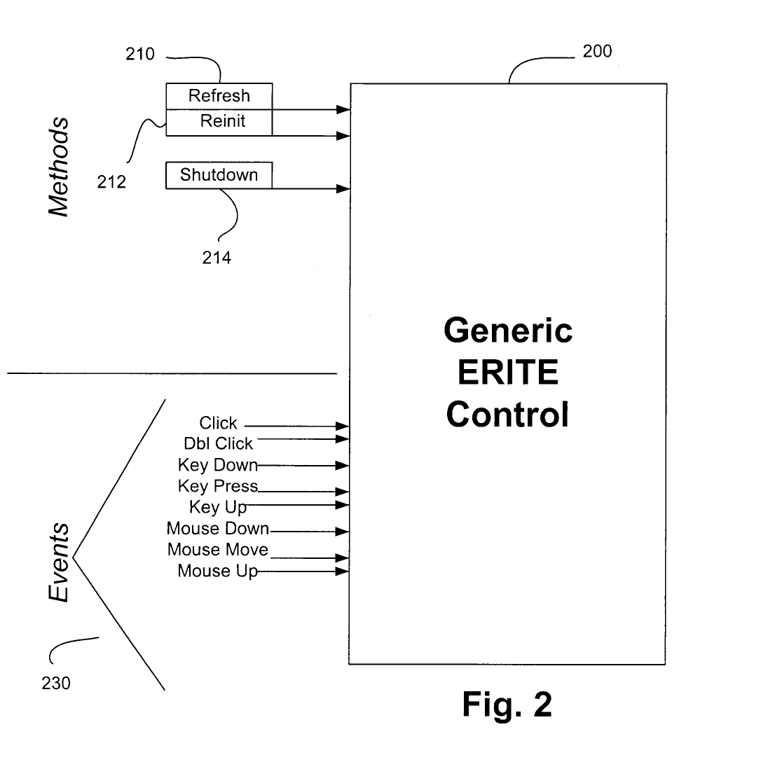

FIG. 2 depicts a control 200 within an operating environment in accordance with an embodiment of the present invention. Control 200 may receive commands from a user that cause control 200 to perform a specific method or action. In performing the action, control 200 may use its control pointer array, such as control pointer array 120, to access other controls within the operating environment. The pointers should indicate the controls accessible by control 200 that are listed in the support members string, such support members string 112.

Control 200 may receive commands such as refresh 210, reinitialize 212, and shutdown 214. Refresh 210 represents a refresh method that causes any graphical displays on control 200 to repaint. A refresh method should be used when the display is to be current, such as a moving target or icon. Reinitialize 212 represents a reinitialize method that causes control 200 to reset itself to “startup” conditions. Startup conditions may be the state wherein control 200 has no values within its data structure, or preset values that are retrieved from memory. For example, all counters may be reset, and graphics and properties are returned to their original state. Alternatively, startup conditions may indicate any condition for control 200 that is a common default. A reinitialize method should be used when the user of control 200 changes.

Shutdown 214 represents a shutdown method that disables the entire software program, or project, executing in the operating environment. In order to resume, the program should be restarted. A shutdown method may be used with a timer and a password dialog to prevent an unattended unit from being used by unauthorized personnel. Shutdown 214 may be different from other security measures employed by the operating environment, such as validation and identification measures.

Events 230 are the actions to be taken for control 200. Events 230 may include click, double click, key down, key press, key up, mouse down, mouse move, mouse up, and the like. As control 200 performs the methods requested, control 200 may perform the events to manipulate the data stored on the device and being used by the software program executing in the operating environment.

Additional commands may be received by control 200. Further, control 200 may perform additional methods and have additional events occur. Control 200 may access other controls and their properties in completing the methods according to the pointer array within control 200.

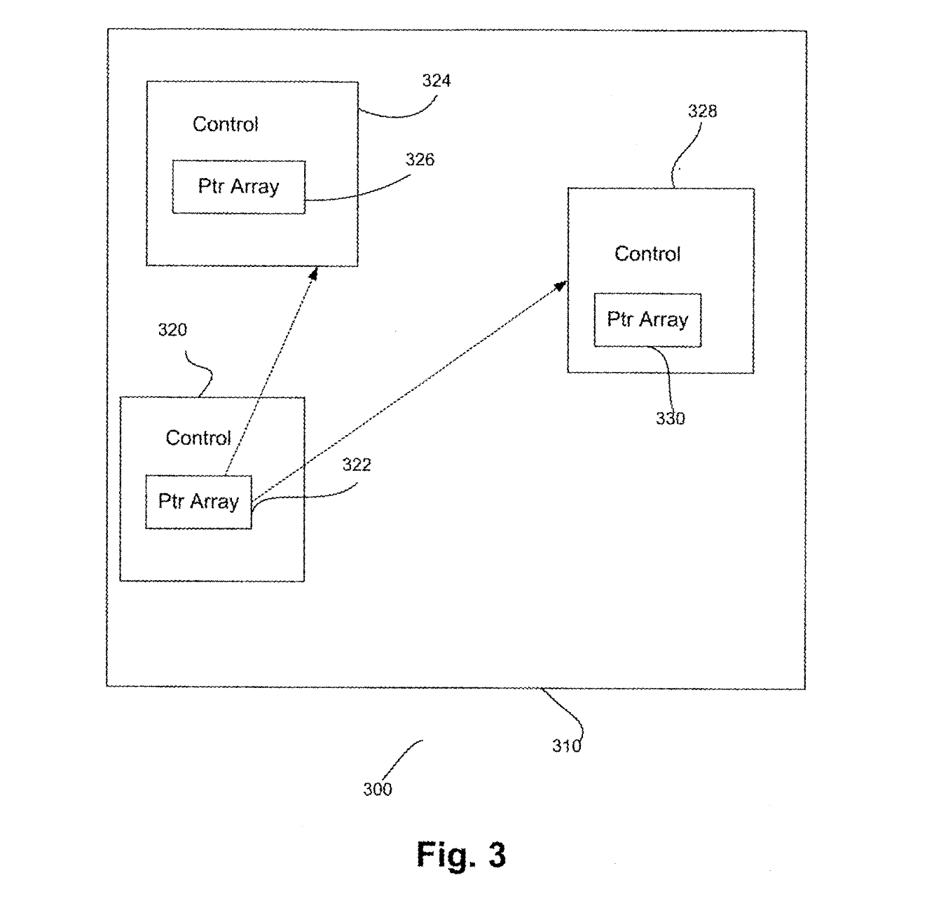

FIG. 3 depicts a plurality of controls 320, 324, and 328 within an operating environment 310 in accordance with an embodiment of the present invention. Operating environment 310 may reside on computing device 300. As disclosed above, computing device 300 includes a processor, a memory coupled to the processor, and a means, such as software code, for executing instructions stored in the memory. A software program stored on computing device 300 may execute within operating environment 310.

Controls 320, 324, and 326 may cooperate with software programs executing within operating environment 310 in manipulating data stored on device 300. Preferably, controls 320, 324, and 326 may manipulate graphical data according to user commands. Controls 320, 324, and 326 may act as user interfaces within operating environment 310 to provide functionality to the software programs.

Control 320 includes pointer array 322. As disclosed above, a control may use a control pointer array to access properties and methods of compatible controls listed within the control's support members string. Thus, pointer array 322 may access properties and methods within controls 324 and 328. Controls 324 and 328 should be listed within the support members string of control 320. Alternatively, if, for example, control 328 is not listed within the support members string of control 320, then pointer array 322 may not access the properties and methods of control 328. Control 324 includes pointer array 326 and control 328 includes pointer array 330.

For example, control 322 may be a compass control and control 328 may be a map control. Control 328 may not need a compass control, while control 322 may need a map control to be of any use to computing device 300. If a user indicates “North” on a compass icon displayed on computing device 300, then control 322 would desire a map graphic to go north on. Thus, control 322 lists control 328 in its support members string and has a pointer to control 328 in its pointer array 322.

Control 324 may be a macro control that has been placed into operating environment 310. Control 324, as a macro control, may not be of immediate concern to control 328, which is a map control. Control 328, however, is made aware of control 324 as it is placed into operating environment 310. Operating environment 310 facilitates these relationships by receiving initial information from the strings within the controls and ensuring that controls 320, 324, and 328 are able to exchange information with each other. Thus, the sequence of placing controls 320, 324, and 328 within operating environment 310 should not be a factor. Thus, controls 320, 324, and 328 may be incorporated dynamically and automatically.

Operating environment 310 may act as a manager by validating controls 320, 324, and 328. Operating environment 310 may perform a security procedure regarding the key string of each control. Operating environment 310 may incorporate a randomly generated number appended to the key strings sent from the respective controls. A certain string may be added to the received string and sent back to controls 320, 324, and 328. Depending on the status of the modified strings, controls 320, 324, and 328 may be registered into operating environment 310.

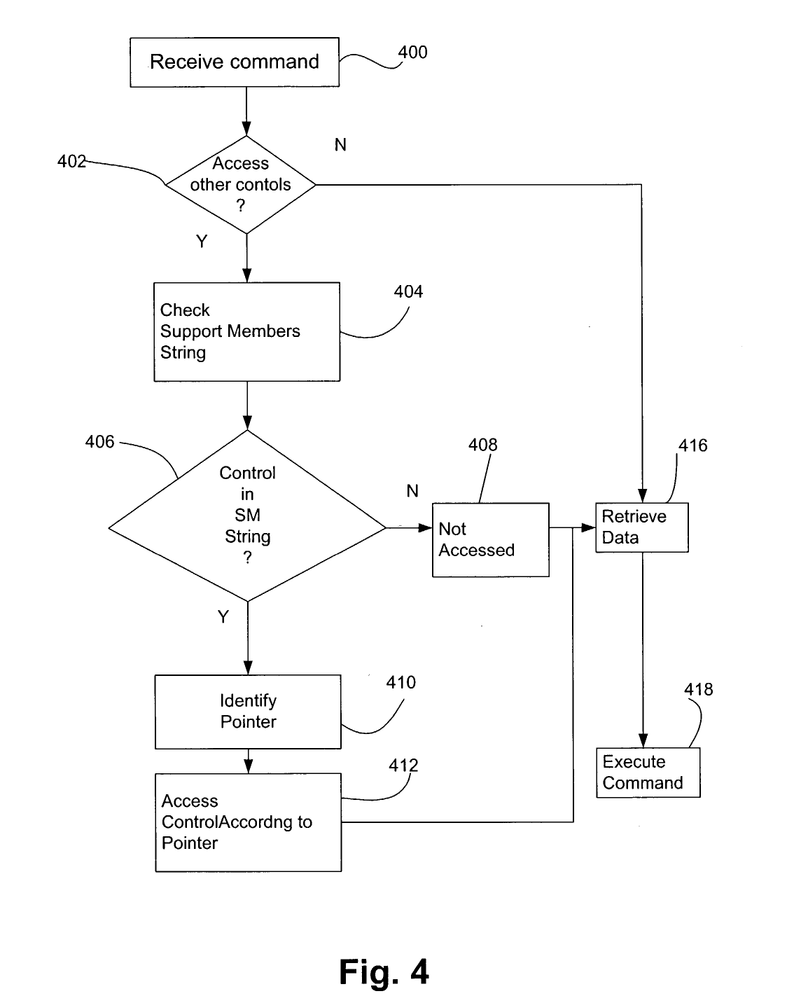

FIG. 4 depicts a flowchart for accessing controls in accordance with an embodiment of the present invention. Preferably, the controls are accessed to manipulate data stored on a computing device that hosts the controls. Step 400 executes by receiving a command at a control, as disclosed above. The command may task the control to access other controls for properties and methods before retrieving the data to execute the command. For example, a map control may receive a command to refresh, and desires to access other controls for properties or methods before retrieving map data from memory. The control receiving the command may be known as the receiving control.

Step 402 executes by determining whether other controls should be accessed. If yes, then step 404 executes by checking the support members string of the receiving control for controls that have been acknowledged and identified by the receiving control. As controls are added to the operating environment, those controls that are of interest to the receiving control may be listed in its support members string. The operating environment may manage the allocation and identification of the controls, and indicate to the receiving control that a control should be listed in its support members string.

Step 406 executes by determining whether the control to be accessed is within the support members string. If no, then step 408 executes by not accessing a control. An error may be indicated to the operating environment. Alternatively, the operating environment and/or the receiving control may do nothing. If yes, then step 410 executes by identifying the pointer associated with the control listed in the support members string. The receiving control has a control pointer array with pointers to the different accessible controls.

Step 412 executes by accessing the control indicated by the pointer. Thus, the receiving control may link with another control within the operating environment without “turning on” that control. Further, the receiving control should not have to shut itself down to access or retrieve the properties or methods of the other control. Controls may interact in a benign manner without overly taxing the operating environment or memory requirements of the software using the control.

Step 416 executes by retrieving the data desired to execute the command from memory, or other data storage device, on the computing platform. Step 416 also may execute if step 402 is no, or after step 408 when the desired control is not accessible by the receiving control. For example, for a map control, step 416 may retrieve the desired map graphical data from memory, or download the information from another source. Step 418 executes by executing the command received by the control.

Although controls have been disclosed generally, specific types of controls may be applicable to the disclosed embodiments. These controls may be used to manipulate graphical data on a computing device, or to update displayed graphics as new data is received. The disclosed controls, however, are for illustrative purposes only, and the controls applicable to the disclosed embodiments may not necessarily correspond to the controls disclosed below.

One control may be a data control that allows a user to indicate appropriate data, or implement an auto refresh. An information control may setup filters within the operating environment to prevent redundant or erroneous information from being exchanged. The filters may be part of the security features within the computing platform, and may allow different capabilities to different software components, including controls.

A mode control may be implemented that enables buttons on the display to inform the manager what information to retrieve, such as maps, location data, and the like. The type of mode may determine how the information is to be displayed on the computing device. For example, different maps may be used for different scenarios. Clicking a button on the display may change the maps.

An active track data control also may be implemented to enable the operating environment to display or present itself in a different manner to the outside world. Each track for data on the display may be a separate entity that floats above the displayed graphic, such as a map. The track may be responsive to a mouse or cursor instruction. The data for the track may be received at the computing device, preferably in a wireless manner. As information is received, then the track may be updated as it floats above the graphic display.

It will be apparent to those skilled in the art that various modifications and variations can be made in the wheel assembly of the present invention without departing from the spirit or scope of the invention. Thus, it is intended that the present invention embodies the modifications and variations of this invention provided that they come within the scope of any claims and their equivalents.

What is claimed is:

1. A control for manipulating data stored in memory coupled to a processor, wherein said processor receives data to associate with said data within an operating environment, comprising:
a support members string to list a compatible control within said operating environment; and
a pointer array having a pointer indicating said compatible control, wherein said pointer is used when said control accesses said compatible control.

2. The control of claim 1, further comprising a type string to identify said control to said operating environment.

3. The control of claim 1, further comprising a key string for registering said control with said operating environment.

4. The control of claim 3, wherein said key string is sent to said operating environment from said control.

5. The control of claim 1, further comprising a self reference pointer.

6. The control of claim 1, further comprising a manager pointer.

7. The control of claim 1, wherein said pointer array includes additional pointers to access additional controls.

8. The control of claim 1, further comprising a twip width for said control.

9. The control of claim 1, further comprising a twip height for said control.

10. A system having a control for manipulating data within an operating environment, comprising:
a command received at said control;
a pointer array within said control that indicates another control to be accessed in response to said command; and
a display for said operating environment, wherein said control executes a method in response to said command using said another control to enable an event on said display.

11. The system of claim 10, wherein said command corresponds to a user input at said control.

12. The system of claim 10, wherein said another control includes an additional property accessible by said control.

13. The system of claim 10, wherein said another control includes an additional method accessible by said control.

14. The system of claim 10, wherein said control is comprised of properties.

15. The system of claim 10, wherein said control includes a support members string to list said another control.

16. The system of claim 10, wherein said operating environment resides on a computing device, said computing device comprising a processor, memory, and executable programs.

17. The system of claim 10, further comprising a program of executable instructions that uses said control to manipulate said data.

18. The system of claim 10, wherein said data is graphical data.

19. The system of claim 10, wherein said data is stored in a memory accessible by said operating environment.

20. A computing device having an operating environment for executing a software program, wherein said computing device includes a processor coupled to a memory storing instructions for said software program, comprising:
a first control having a first type string and a first pointer array, wherein said first type string identifies said first control to said operating environment;
a second control having a second type string, wherein said second type string identifies said second control to said operating environment; and
a first pointer within said first pointer array that identifies said second control to said first control such that said first control accesses said second control.

21. The computing device of claim 20, wherein said second control includes a second pointer within said second pointer array such that said second control accesses said first control.

22. The computing device of claim 20, wherein said second type string is listed within a support members string of said first control.

23. The computing device of claim 20, wherein said first control accesses a property from said second control.

24. The computing device of claim 20, wherein said first control accesses a method from said second control.

25. The computing device of claim 20, wherein said first control manipulates data stored in said memory.

26. A method for accessing a second control from a first control within an operating environment, wherein said operating environment includes a software program utilizing said first and second controls, comprising:
determining whether said second control is listed within a support members string of said first control;
identifying a pointer within a pointer array in said first control according to said support members string; and
accessing said second control according to said pointer.

27. The method of claim 26, further comprising retrieving a type string for said second control from said support members string.

28. The method of claim 26, further comprising receiving a command at said first control that causes said first control to access said second control.

29. The method of claim 26, further comprising retrieving data for said software program using said first control.

30. The method of claim 29, wherein said retrieving includes retrieving said data from a memory coupled to said operating environment.

31. The method of claim 30, further comprising downloading said data into said memory from a data storage.

32. A system for manipulating data for a software program executing in an operating environment, comprising:
a control identified by said operating environment, wherein said control manipulates said data in response to a user input; and
a pointer array within said control to identify another control accessible by said control, wherein said operating environment sets a pointer within said pointer array to identify said another control.

33. The system of claim 33, wherein said control includes a support members string to list said another control correlating to said pointer.

34. A method for manipulating data stored within a memory coupled to an operating environment having a plurality of controls, comprising:
determining whether a first control is compatible with a second control;
identifying a pointer within said first control that correlates to said second control;
accessing said second control from said first control; and
retrieving data from said memory according to said first control.

35. The method of claim 34, further comprising identifying said second control to said first control via said operating environment.

36. The method of claim 34, wherein said retrieving includes downloading said data from said memory.

37. The method of claim 34, further comprising accepting said first control according to a key string.

38. The method of claim 34, further comprising manipulating said data according to an accessed property from said second control.

39. The method of claim 34, further comprising manipulating said data according to an accessed method from said second control.

40. The method of claim 34, further comprising receiving a command at said first control to manipulate said data with an event at said first control.

41. A method for constructing a control to access another control within an operating environment, comprising:
receiving a modified type string at said control from said operating environment for said another control;
placing said modified type string in a support members string within said control; and
assigning a pointer within said control to access said another control according to said modified type string.
